(19) United States
(12) Patent Application Publication
(10) Pub. No.: US 2018/0041679 A1
(43) Pub. Date: Feb. 8, 2018

(54) SYSTEM AND METHODS FOR VARIABLE IMAGE CAPTURE

(71) Applicant: MINDHIVE INC., New York, NY (US)

(72) Inventors: George Dalke, Claremont, NH (US); Howard Gould, New York, NY (US)

(21) Appl. No.: 15/483,705

(22) Filed: Apr. 10, 2017

Related U.S. Application Data
(60) Provisional application No. 62/370,974, filed on Aug. 4, 2016.

(51) Int. Cl. H04N 5/238; G03B 13/36; H04N 5/232

(52) U.S. Cl. CPC H04N 5/238; H04N 5/23293; G03B 13/36

(57) ABSTRACT

The invention generally relates to systems and methods for capturing a series of images with variable focus and exposure values. Upon initiation of an image capture routine, a series of images is captured while focal length and exposure value are changed such that the delay associated with conventional autofocus systems is avoided and images with multiple objects at various depths are captured in focus in one or more of the images of the series.

### RELATED APPLICATIONS

This application claims priority to and the benefit of U.S. Provisional application Ser. No. 62/370,974, filed Aug. 4, 2016. The contents of the above-referenced application are incorporated by reference herein in their entirety.

### FIELD OF THE INVENTION

The invention generally relates to methods and systems for capturing a series of images with variable focus and exposure values.

### BACKGROUND

Digital images are cheap and easy to capture and use and with digital cameras becoming an everyday accessory found on cell phones, tablets, and other mobile devices, people are photo-documenting more and more of their everyday lives. People want and expect to be able to capture and share images of daily events as they happen. In practice, people want the ability to spontaneously capture images of events in real time with no advance notice or preparation. The primary tool for capturing these images is the ever-present camera phone that people carry with them everywhere.

Unfortunately, because the cell phone is tasked with functioning as at least a computer, a keyboard, and a telephone while remaining compact and thin, the phone's camera is not always up to the task of quickly and accurately capturing images. Notably, the cell phone camera's ability to quickly autofocus, determine exposure and capture and image is often outpaced by the action a user is trying to capture. This noticeable delay between pressing the image capture button and the picture actually being taken can result in frustration and missed photo opportunities for the user. People are often unable to capture clear, spur of the moment images of spontaneous events in their lives. The resulting images may be blurry, focused on the wrong object, or otherwise lacking in quality. Because these images are often of spontaneous events, it is not possible to go back and recreate the image and people are left with unusable or lackluster digital memories.

### SUMMARY

The invention generally relates to systems and methods for variable focus and exposure image capture. The invention provides for a series of images to be captured based on a single instruction (e.g., a touch of a button or touch screen by a user indicating a desire to capture an image) where the focal length and/or the exposure value are varied throughout the series such that various objects within the frame at different depths are captured in focus with appropriate exposure values.

Systems and methods of the invention provide for quicker response time than traditional autofocus systems by avoiding overrun in the lens position motor and capturing a continuous series of images throughout the focal lens movement. Additionally, the invention provides the ability to retrospectively select one or more objects of disparate depths in the image field to focus on. This ability, combined with display and user input systems allows a user to review and select certain images from the series of captured images. In doing so, a user may uncover desirable subject matter in the image field that were not initially perceived at the time of image capture. In certain embodiments image selection may be automated based on computer analysis of the series of images to select the best focus and/or exposure value.

Because focus and exposure are often governed by mechanical systems, their response time is determined by the mass of the moving components, the forces (e.g., friction) acting on those components, and the springs or motors moving the components. Particularly with respect to auto-focusing, the elements are part of a feedback system where the mechanical focusing components are moved based on a measured input, checked, and then moved again which can result in a considerable delay in stabilizing the components at an optimal setting.

Aspects of the invention include a method for image capture. Steps of the method include receiving an input to initialize an image capture and, in response to the input, capturing a series of images with an imaging sensor while moving a lens in relation to the imaging sensor and varying exposure value such that the series of images are captured at a plurality of focal lengths and a plurality of exposure values.

In certain embodiments, steps of the method may include selecting one or more images comprising the series of images where the one or more images comprises a desired focus on a subject and a desired exposure value. Steps of the method may include displaying the series of images on a display, receiving a selection of one or more images comprising the series of images from a user input device, and associating the selection with the one or more of the series of images in a tangible, non-transient memory.

The input to initialize the image capture may be a movement of the imaging sensor or, may be received from a user input device (e.g. a user interaction with a hard button or soft button on a touch screen). Varying exposure value may be accomplished by varying shutter speed of a shutter that permits light to reach the imaging sensor or varying size of an aperture that permits light to reach the imaging sensor.

In various embodiments, one or more steps of the method may be carried out by a computer device comprising a tangible, non-transient memory coupled to a processor. The series of images may include a video. The focal length can be changed from a lower value to a higher value a single time while the exposure value is varied between a lower value and higher value multiple times.

In certain aspects, the invention may include a system for image capture including an imaging sensor, a lens, and a computer device comprising a processor coupled to a non-transient, tangible memory. The computer device may be operably coupled to a motor that is in turn operable coupled to the lens and configured to change the position of the lens in relation to the imaging sensor. The computer device may be operable to receive an input to initialize an image capture and, in response to the input, capture a series of images with the imaging sensor while moving the lens in relation to the imaging sensor with the motor and varying exposure value such that the series of images are captured at a plurality of focal lengths and a plurality of exposure values.

In certain embodiments, the computer device can be further operable to select one or more images comprising the series of images wherein the one or more images comprises a desired focus on a subject and a desired exposure value. The computer device may be further operable to display the series of images on a display, receive a selection of one or more of the series of images from a user input device, and associate the selection with the one or more of the series of images in the tangible, non-transient memory.

The input to initialize the image capture may be received from a user input device in communication with the computer device. In various embodiments, systems of the invention may include a shutter, in communication with the computer device, that permits light to reach the imaging sensor, the computer device operable to vary exposure value by varying an amount of time that the shutter is open for each of the series of images to be captured. Systems may include a variable aperture, in communication with the computer device, that permits light to reach the imaging sensor, the computer device operable to vary exposure value by varying the size of the aperture during the capture of the series of images.

In some embodiments, the computer device may be further operable to change the focal length using the motor from a lower value to a higher value a single time while the exposure value is varied between a lower value and higher value multiple times. The computer device may be further operable to change the focal length using the motor from a higher value to a lower value a single time while the exposure value is varied between a lower value and higher value multiple times.

### BRIEF DESCRIPTION OF THE DRAWINGS

FIG. 1 illustrates focal length using a lens, imaging sensor, and objects at various depths.

FIG. 2 illustrates lens position over time using prior art autofocus systems.

FIG. 3 illustrates a graph of exposure and lens position varying over time during a series of image captures according to systems and methods of the invention.

FIG. 4 illustrates objects at varying depth, images of which may be captured using systems and methods of the invention.

FIG. 5 gives a more detailed schematic of components that may appear within a system.

FIG. 6 illustrates a graph of exposure and lens position varying over time with lens position varying in a series of steps.

### DETAILED DESCRIPTION

The invention provides systems and methods for capturing a series of images while varying focal length, exposure value, or both. By capturing images during the focal lens adjustments and/or calculation and adjustment of the exposure value through light metering, shutter speed, and aperture size, much of the delay associated with autofocus systems can be avoided. The invention then provides for automated processing or user involved selection of the one or more images from the set that best capture the desired subject. By capturing subjects in focus at various depths in the field of view, a user may be able to capture in focus images of several different subjects of interest quickly, thereby allowing the user to more fully document experiences in real time.

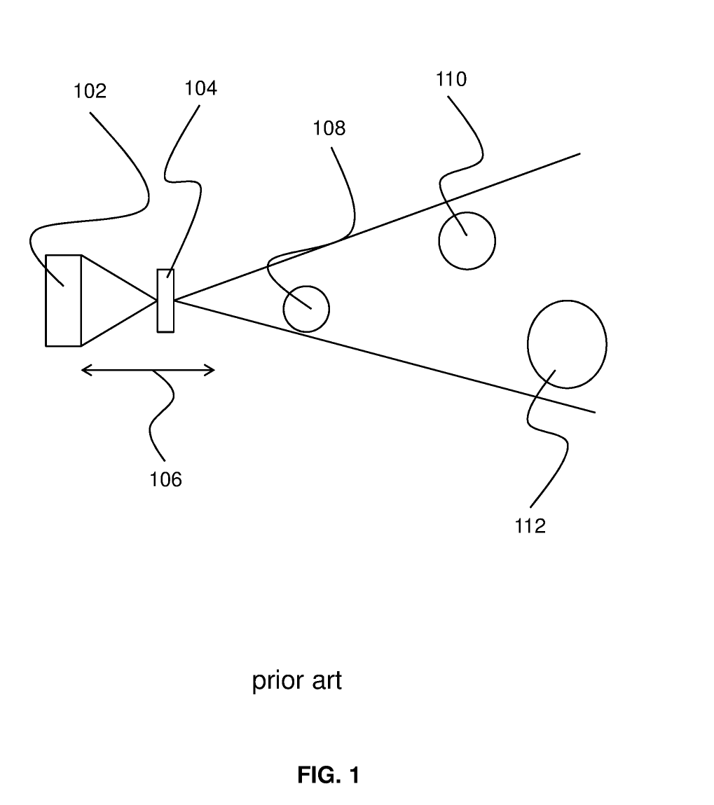

Image focus, as shown in FIG. 1, depends on the position of a lens 104 in relation to both a subject and the film or, in the case of a digital camera, the imaging sensor 102. When dealing with multiple subjects, the lens position must be varied along axis 106 to change the image focus between a first object 108, a second object 110, and a third object 112, at varying depths or distances from the imaging sensor 102. In digital cameras, the task of changing the lens position is accomplished via a motor that can move the lens 104 closer and farther away from the imaging sensor 102 along the axis 106. In cameras equipped with autofocus, a sensor measures the distance between the imaging sensor and the subject to be focused or analyzes the images as they enter the imaging sensor 102 to determine proper focal length.

Due to the compact nature and diverse requirements for the limited space in most mobile devices (e.g., processors, speakers, microphone, transmitters, displays, receivers), the cameras in the devices must be compact and, therefore, cannot house complicated autofocus devices and sensors or lens motors.

Another important aspect of image quality is exposure value. Exposure value relates to the amount of light taken in by the imaging sensor in a single image capture. Accordingly, in applications using a shutter to allow light to pass to the imaging sensor, exposure value can be altered by changing shutter speed (i.e., the amount of time the shutter is open) and the shutter aperture size. While the exposure value is light dependent, the ratio of shutter speed to aperture size used to achieve a desired exposure value can depend on the subject of the image. For example, capturing a fast moving object will require a fast shutter speed to avoid a blurry image through long exposure time and a the exposure value should therefore be altered by increasing the aperture size instead. Aperture size also effects depth of field, where a small aperture size provides a deeper depth of field than a large aperture size.

For the camera to take a picture, a signal must be sent to the camera to initiate the photo taking process. At that point, the imaging sensor or a separate distance or lens focus sensor and light meter must determine the object to be focused on, the distance of the object and the required lens position to achieve proper focus along with the correct exposure value based on both ambient light, anticipated flash illumination, and movement of the object (e.g., sports vs. landscape photography). After determining the desired settings using the sensors and a processor, the camera must set the proper focal length and take the picture.

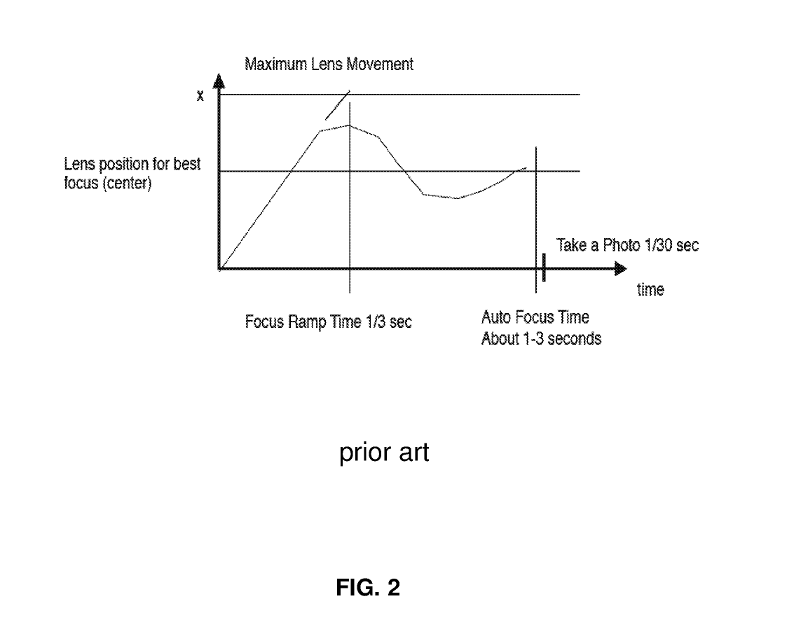

Unfortunately, the small motors acting on the lens are imperfect and end up overshooting the correct focal length and oscillating around it until achieving focus and taking the picture. FIG. 2 depicts this process, which can result in a 1-3 second delay between instructing the device to take a picture (e.g., pressing the image capture button on a cell phone screen) and the image actually being captured. This delay can cause an individual to miss the event they were trying to capture, especially in the ad hoc photography world enabled by mobile device cameras where people often expect to chronicle all aspects of their lives and environment with photographs.

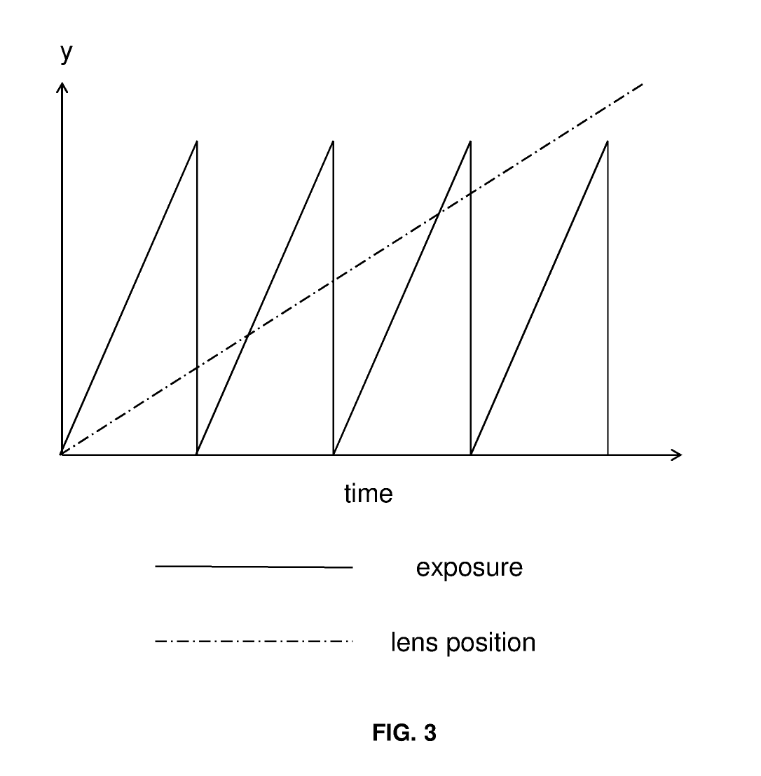

Focus and exposure systems generally have both transient and steady state behaviors with various decays and oscillations for example as shown in FIG. 3.

Modern cameras, including cameras on mobile devices, can also determine aperture and shutter speed or equivalent settings automatically based on readings of ambient light and other information. This automatic determination and application of settings, however, takes additional time, which further delays the period between initializing an image capture and actual capture of the image.

Systems and methods of the invention overcome this delay by capturing a series of images while the lens position is altered. In certain embodiments, the lens position may begin at one limit of its range of motion and cycle to the opposite limit. For instance, the lens may start in its closest physical proximity to the imaging sensor and move to its location of furthest physical distance from the imaging sensor, all while capturing a series of images. The lens may alternatively be moved from any selected focal point to another selected focal point while the series of images is captured. In certain embodiments, the lens position may be cycled back and forth 1, 2, 3, 4, 5, 6, or more times while capturing a series of images.

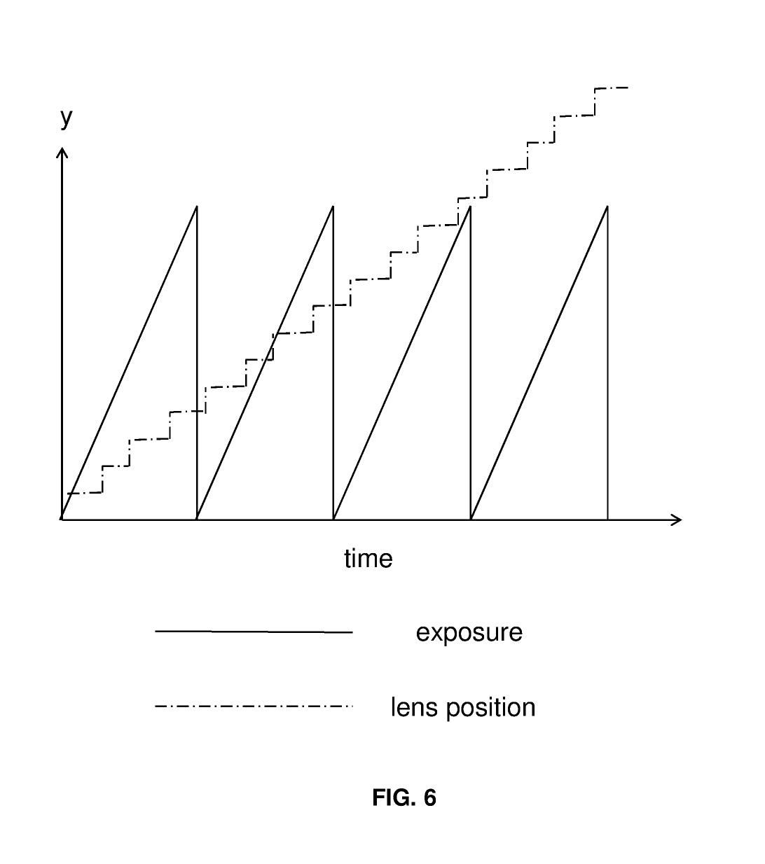

Images can be captured at a fixed rate or shutter speed and/or a fixed aperture to deliver a fixed exposure value throughout the focal range. Alternatively, exposure value may be additionally altered simultaneously to the lens position. FIG. 3 illustrates exposure value and lens position alterations made over time while a series of images are captured according to one embodiment. In FIG. 3, the lens position follows a single ramp away from the imaging sensor while the exposure value is cycled between its higher and lower values 5 times. The exposure value may be cycled any number of times, for example, 1, 2, 3, 4, 5, 6, 7, 8, 9, 10, or more. In preferred embodiments, the exposure value is cycled at least 4 or more times such that there are a number of exposure values captured for a small range of focal lengths. Exposure value may be varied according to methods of the invention through modification over time of the shutter speed or equivalent image exposure time if no shutter is present; modification over time of the aperture size or equivalent; or a combination of both. Images may be captured as a video throughout a smooth movement of the lens position away or toward the imaging sensor. In certain embodiments, lens movement may be momentarily paused in a series of steps as shown in FIG. 6 while an image is captured at each step in order to avoid possible blurring of the captured image.

Systems and methods of the invention may continuously capture images while varying the focus and/or exposure by moving a physical component corresponding the focus or exposure system using, for example, some combination of steps (e.g., moving the system component to another position and pausing), ramps (e.g., continuously moving the system component through a range of values), or sinusoids (e.g., continuously moving the system component in an oscillating pattern through a range of values). The above techniques may be applied, in any combination, to focus, exposure, or both. Preferably, the system variability will be such that each of the collected images comprise a perceptibly different focus and/or exposure combination while allowing for continuous image capture.

In certain embodiments, both operations (focus and exposure) may be varied in a sinusoidal pattern. For example, the focus and exposure parameters may oscillate at nearby frequencies in a coupled system such that a plot of their values resembles a Lissajous curve. Focus and exposure variability patterns may be selected such that images are captured at multiple focal values for a given exposure value and/or multiple exposure values for a given focal value. These related images can then be extracted and grouped by a processor for presentation to a user so that a user, having a found a desired focus, can limit their further review to images at that focus with a variety of exposure values.

By varying the focal length and exposure value while capturing a series of images, image capture can begin as soon as initiated by a user, thereby avoiding the delay found with current autofocus systems. After the series of images has been captured, the image or images of the series with the best focus on the desired subject along with the best exposure value and depth of field may be selected from the series. The selection process may be automatic and determined by a computer device including a processor and a tangible non-transient memory, or may be determined through user interaction with a input-output device. In certain embodiments, a combination of the automatic and manual selection processes may be used wherein the series of images is initially curated or paired down by the computer (e.g., to remove unfocussed or over or under exposed images) before the curated image set is presented to a user for further review and selection.

In various embodiments, image sets may be presented to the user through an input/output device such as a display. The user may interact with the display through an input device such as a touch screen, keyboard, or mouse to select the images of the image set that provide the focus and exposure value that the user desires. In certain embodiments, the series of images may be displayed to the user as a static image permitting the user to adjust focus and exposure levels as they would with a live image (e.g. sliding fingers on a touch screen or indicating, via the touch screen, an object or portion of the image to bring into focus). Systems and methods of the invention may be further operable to identify the parameter alterations requested by the user through the user input device (e.g., altered zoom, exposure, or focal object) and select and display an image from the series that comprises the desired parameters. In certain embodiments, systems and methods of the invention may provide transitions (e.g. gradually changing the image through a series of alterations between the parameters of the first image and the parameters of the second image) between the initial static image and a secondary static image from the series to effectively blend or blur the transition by displaying one or more intermediary images which may be other images selected from the series or created synthetically through blending of the images.

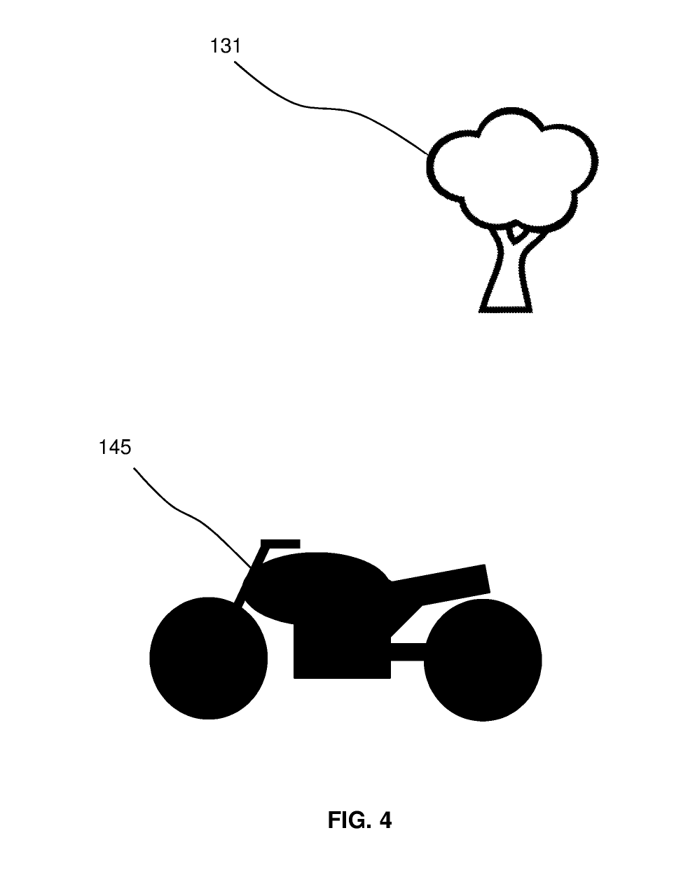

In addition to providing a quicker image capture than traditional autofocus methods described above, systems and methods of the invention also provide for later selection of photo subjects from a particular point of view. For example, a user may take a picture of a crowd or a scene with multiple points of interest at different distances. Although the user may have initially been interested in one of the closer objects, if the user later determines that an object further away is of interest, the user may find another image in the series that was captured with the further object in focus. FIG. 4 illustrates a scene wherein a user may be taking a picture of a tree 131 that is far away when a motorcycle drives past much closer 145. While the user was initially interested in the tree 131, the motorcycle 145 may also be of interest but would be out of focus in an image captured using previous methods. Because the motorcycle 145 may have been driving, it may then be too late for the user to refocus and take another picture of the motorcycle 145. Methods of the present invention can alleviate this problem by capturing a series of images (e.g., a video) at various focal lengths and/or exposure values and then allowing the user to review them after the fact and select the image that best captures the subject they are interested in. Using methods and systems of the invention applied to the scene in FIG. 4, the user could review the series of images and select one with the tree 131 in focus and another with the motorcycle 145 in focus.

In certain embodiments, systems and methods of the invention may be applied to augmented reality images wherein the real-world live image portion of an augmented reality image is captured according to the methods described herein (e.g., a series of images with variable parameters). In such embodiments, an image from the series may be selected automatically by the processor based on the best interaction with the virtual components of the augmented reality image (e.g., what focus or exposure values best integrate the virtual component into the image). For example, an image having a focal length parameter that brings the immediate area where the virtual component is placed into focus may be selected. In certain embodiments, an augmented reality image may be altered to, for example, take a virtual component of the image out of focus based on its perceived location within the actual image frame at the focus and exposure values selected by the user or the computer.

As noted above, image review and selection may be made using, for example, a touch screen display such as those found on mobile devices (e.g., tablets and cell phones). In the context of today's fast-pace social media driven world with rampant photo-documenting of live events, there is little time to determine a desired subject and set up a camera phone to capture the image that may prove to be the most interesting later. Systems and methods of the invention allow the user to automatically capture a series of images at various settings with a single instruction (e.g., screen touch) so that the user can review later to select the best images once the moment has passed.

Once selected, either automatically or through user input, the selection may be associated with the selected images or image files. The series of images may be stored in memory on the computer device or on a remote storage memory on a server or other computer device in communication with the camera through a network. The series of images may be stored in memory indefinitely for later review or may be automatically removed from storage after a selected period of time or after a selected number of reviews (e.g., 1, 2, 3, 4, or 5). In certain embodiments, after a selection of images of the series has been made, the selected images may be retained while the unselected images are deleted from storage.

In certain embodiments, multiple images from sets obtained according to the above methods may be combined in whole or part in order to present a single image comprising components of the multiple images. Accordingly, dynamic range and signal to noise ratios may be improved using images of the same subject taken at varying exposures or slightly different times.

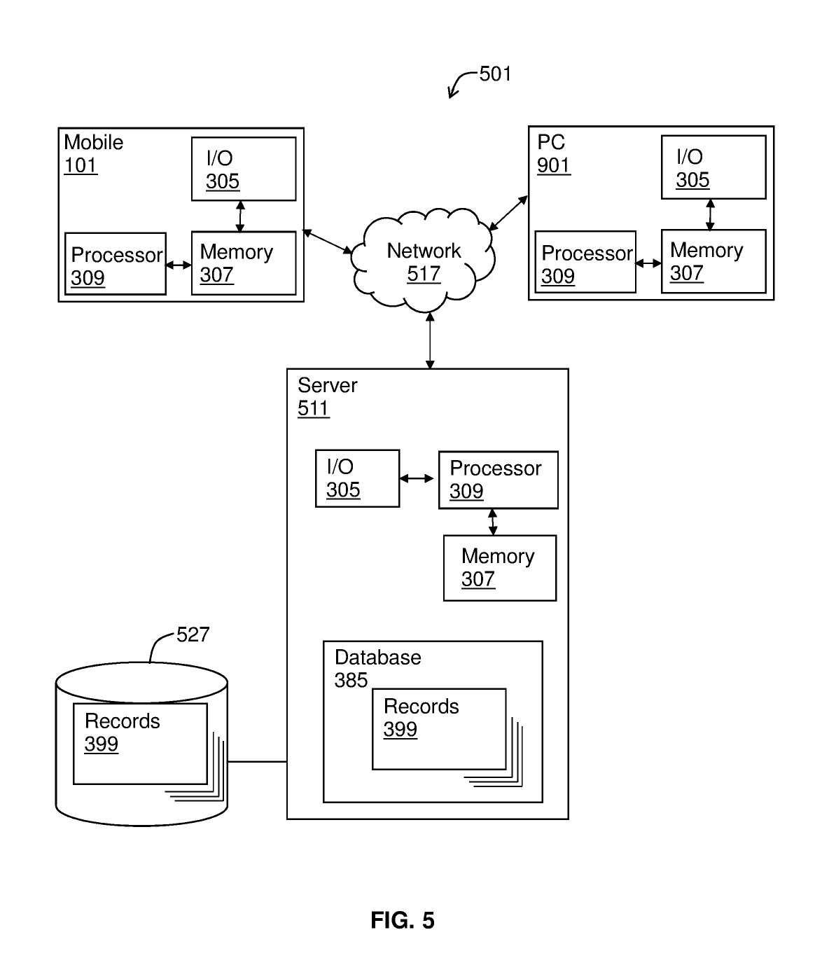

As one skilled in the art would recognize as necessary or best-suited for the systems and methods of the invention, systems and methods of the invention may include computing devices as shown in FIG. 5 that may include one or more of processor 309 (e.g., a central processing unit (CPU), a graphics processing unit (GPU), etc.), computer-readable storage device 307 (e.g., main memory, static memory, etc.), or combinations thereof which communicate with each other via a bus. Computing devices may include mobile devices 101 (e.g., cell phones), personal computers 901, and server computers 511. In various embodiments, computing devices may be configured to communicate with one another via a network 517 in order to display image series or allow remote storage, viewing, or selection of images of a given series.

A processor 309 may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory 307 preferably includes at least one tangible, non-transitory medium capable of storing: one or more sets of instructions executable to cause the system to perform functions described herein (e.g., software embodying any methodology or function found herein); data (e.g., portions of the tangible medium newly re-arranged to represent real world physical objects of interest accessible as, for example, a picture of an object like a motorcycle); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage 527 such as, for example, Amazon Web Services, memory 307 of server 511, cloud storage, another server, or other computer-readable storage. Cloud storage may refer to a data storage scheme wherein data is stored in logical pools and the physical storage may span across multiple servers and multiple locations. Storage 527 may be owned and managed by a hosting company. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to allow the operability described herein for various systems and methods of the invention. For example, systems and methods herein can be implemented using Perl, Python, C++, C#, Java, JavaScript, Visual Basic, Ruby on Rails, Groovy and Grails, or any other suitable tool. For a computing device 101, it may be preferred to use native xCode or Android Java.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A method for image capture comprising:
receiving an input to initialize an image capture; and
in response to the input, capturing a series of images with an imaging sensor while moving a lens in relation to the imaging sensor and varying exposure value such that the series of images are captured at a plurality of focal lengths and a plurality of exposure values.

2. The method of claim 1 further comprising:
selecting one or more images comprising the series of images wherein the one or more images comprises a desired focus on a subject and a desired exposure value.

3. The method of claim 2 further comprising:
displaying the series of images on a display;
receiving a selection of one or more images comprising the series of images from a user input device; and
associating the selection with the one or more of the series of images in a tangible, non-transient memory.

4. The method of claim 1 wherein the input to initialize the image capture is a movement of the imaging sensor

5. The method of claim 1 wherein the input to initialize the image capture is received from a user input device.

6. The method of claim 1 wherein varying exposure value comprises varying shutter speed of a shutter that permits light to reach the imaging sensor.

7. The method of claim 1 wherein varying exposure value comprises varying size of an aperture that permits light to reach the imaging sensor.

8. The methods of claims 1-7 wherein one or more of the steps are carried out by a computer device comprising a tangible, non-transient memory coupled to a processor.

9. The method of claim 1 wherein the series of images comprises a video.

10. The method of claim 1 wherein the focal length is changed from a lower value to a higher value a single time while the exposure value is varied between a lower value and higher value multiple times.

11. A system for image capture, the system comprising an imaging sensor, lens, and a computer device comprising a processor coupled to a non-transient, tangible memory, wherein the computer device is operably coupled to a motor that is in turn operable coupled to the lens and configured to change the position of the lens in relation to the imaging sensor, wherein computer device is operable to:
receive an input to initialize an image capture; and
in response to the input, capture a series of images with the imaging sensor while moving the lens in relation to the imaging sensor with the motor and varying exposure value such that the series of images are captured at a plurality of focal lengths and a plurality of exposure values.

12. The system of claim 11 the computer device further operable to select one or more images comprising the series of images wherein the one or more images comprises a desired focus on a subject and a desired exposure value.

13. The system of claim 11 the computer device further operable to:
display the series of images on a display;
receive a selection of one or more of the series of images from a user input device; and
associate the selection with the one or more of the series of images in the tangible, non-transient memory.

14. The system of claim 11 wherein the input to initialize the image capture is a movement of the imaging sensor

15. The system of claim 11 wherein the input to initialize the image capture is received from a user input device in communication with the computer device.

16. The system of claim 11 further comprising a shutter, in communication with the computer device, that permits light to reach the imaging sensor, the computer device operable to vary exposure value by varying an amount of time that the shutter is open for each of the series of images to be captured.

17. The system of claim 11 further comprising a variable aperture, in communication with the computer device, that permits light to reach the imaging sensor, the computer device operable to vary exposure value by varying the size of the aperture during the capture of the series of images.

18. The system of claim 11 wherein the computer device is further operable to change the focal length using the motor from a lower value to a higher value a single time while the exposure value is varied between a lower value and higher value multiple times.

19. The system of claim 11 wherein the computer device is further operable to change the focal length using the motor from a higher value to a lower value a single time while the exposure value is varied between a lower value and higher value multiple times.
